(19) United States
(12) Patent Application Publication
(10) Pub. No.: US 2019/0281804 A1
(43) Pub. Date: Sep. 19, 2019

(54) FISH RESTRAINING DEVICE

(71) Applicant: Calvin Liggett, Covington, LA (US)

(72) Inventor: Calvin Liggett, Covington, LA (US)

(21) Appl. No.: 15/922,634

(22) Filed: Mar. 15, 2018

(51) Int. Cl. A01K 97/18; B25J 1/04

(52) U.S. Cl. CPC A01K 97/18; B25J 1/04

(57) ABSTRACT

A fish restraining device to restrain a fish or similar creature during the process of removing a hook from the mouth, while not further harming the fish, and making it possible to either transfer the fish to a container or tank or place the fish back in the water and release it, requiring only one-handed, simple manipulation by the person fishing.

### BACKGROUND

This invention provides a fish restraining device to restrain a fish or similar creature during the process of removing a hook from the mouth, while not further harming the fish, and making it possible to either transfer the fish to a container or tank or place the fish back in the water and release it, requiring only one-handed, simple manipulation by the person fishing.

Fishing, with a line and a hook, especially from a boat or floating structure, is undertaken in conditions of limited space and a moving or potentially moving footing. When a fish is caught, it must be brought on board and have the hook removed from its mouth. The person fishing and bringing the fish on board will likely have other fishing gear, such as a pole or rod, in hand, and might also be occupied with steering, rowing, or other tasks. After being brought on board, the fish will thrash about, making hook removal difficult and perhaps dangerous. If the fish is in a scoop net, then the mouth and hook are difficult to access.

The prior art does not provide for a fish restraining device to restrain a fish or similar creature during the process of removing a hook from the mouth, while not further harming the fish, and making it possible to either transfer the fish to a container or tank or place the fish back in the water and release it, requiring only one-handed, simple manipulation by the person fishing.

For example, U.S. Pat. No. 5,054,226 was issued on Oct. 8, 1991 to Michael F. Hart for a “Universal Bait Holder.” The '226 Patent discloses a device for securing and holding live bait while it is applied to a fish hook. The bait holder is comprised of two sets of opposed slender fingers, which mesh together without harm or injury to the bait. The fingers are curved to present concave surfaces towards the opposed set, to center and position the bait for complete access to all portions of the bait for hook-application purposes.

U.S. Pat. No. 2,643,151, as issued to T. R. Zupancic on Jun. 23, 1953, discloses “Fisherman's Pliers” where the primary object and purpose is to provide a device in the nature of pliers particularly for use by fishermen, for holding a fish while removing fish hooks from the fish. The '151 Patent covers a set of pliers with two complementary wide opposing jaws with integral handle portions, with each of the jaws having an arcuate shaped inner surface and with the outer surface in convex form. A part of the central portion of the jaws is cut out in a U-shaped form, extending inwardly from the front edge of the jaws. The arcuate-inner surface of the jaws has a plurality of serrations formed transversely therein, and a space is also provided between the inner surfaces of the opposed jaws when the jaws are in a closed position. The Zupancic device further covers the above set of pliers with a spiral spring disposed between the handle portions, and with a of one handle to clamp the handles together and maintain the jaws in their means secured on the outer end portion closed position.

Japanese Publication No. 3155469, dated Nov. 19, 2009, was developed to provide a fish-grilling tongue for picking up and grasping a skin burned on a net from a baked fish, when cooking a fish or the link with a fish grill attached to a home cooking stove. The device features comb tips on a comb-shaped clamping portion, with two comb-like clamping portions inserted in the lower part of the grinding net in the interval of the grill of a typical household cooker fish grill, in a manner that prevents the fish from slipping off, and further featuring a structure with several sliding nails facing inward. By further providing non-slip claws on the back of the comb-like pinch, even if the grill tongue is used sideways, it does not come off from the back, which is effective for slippery materials (such as fish), and can be easily held and reversed.

U.S. Pat. No. 1,941,064 was issued on Feb. 3, 1932 to inventor W. H. Wendt, disclosing “Fish Tongs.” The fish tongs are provided with a specially-constructed fish-gripping end, whereby the body of a fish may be completely circled by the gripping jaws of the tongue without injury to the body of the fish. This device features a shank of the fish tongs, which in turn comprises a primary section and an auxiliary section, with each of the sections pivotally connected together. The primary section has a projecting and overhanging tongue, which is bifurcated for receiving the clamping bolt carried by the auxiliary section. In particular, the bolt passes through the elongated slot formed in the auxiliary section. A thumb nut is threaded upon the clamping bolt and is adapted to firmly engage the tongue and firmly lock the primary and auxiliary sections of the shank in extended positions. The bolt or screw may be moved longitudinally within the slot for the purpose of disengaging the bifurcated portion of the tongue when it is desired to fold the auxiliary section back upon the primary section of the shank.

U.S. Pat. No. 4,845,876, issued to Clifford Dodson on Jul. 11, 1989, covers a “Grasping Gaff.” The self-activated gaff responds to contact of a trigger bar, with an object of causing a pair of tongs to close and embrace the object and to lock around the object until released. The gaff uses a piston-like member and a pair of constant force means to couple the piston-like member to the tongs. In particular, the instrument features (a) a hollow head, (b) a pair of tongs pivotally mounted to one end of the head, (c) an elongated handle, (d) means coupling the handle to the other end of the head, (e) a piston-like member reciprocally movable in the head, (f) means coupling the member to the songs to cause the tongs to turn about its pivot axis as the member moves with respect to the head, (g) spring means coupled to the piston-like member for biasing the piston-like member in a direction to move the tongs angularly to a closed position, (h) a first pawl means engaging the piston-like member releasably to hold the piston- like member in a cocked position against the bias force of the spring means, and (i) a trigger means slidably mounted in the head and extending forwardly from the head, coupled to the first pawl means to release the piston-like member upon contact of the trigger means with an object to be grasped by the tongs.

U.S. Pat. No. 3,978,605 was issued on Sep. 7, 1976 to assignee Meto-Plast Corporation of Kalamazoo, Michigan, covering a “Floating Fish Grip.” The fish grip, created by inventor Adam Maruniak, has an over-all specific gravity of less than that of water, which is obtained by constructing the parts of a plastic with a certain specific gravity, and constructing the handle with an air compartment of sufficient size to reduce the over-all specific gravity to less than the specified amount. In the device, the jaws of the fish grip are pivotally mounted on a body, an actuator is slidably mounted in the body, and spring biased levers are pivotally connected to the actuator and to a central portion of each jaw. The linkage includes a rod that is axially movable in an axial bore in the stem of the Y-shaped body member, having one end affixed to the fingergrip and the other end having links pivoted thereto and to the mid-portion of the cheliform jaws. Those links, as well as the cheliform jaws, may be seriated to provide a better gripping action on the device.

U.S. Pat. No. 4,005,897, issued on Feb. 1, 1997 to Joel E. Smith, covers a “Fish Claw.” The fish claw was developed for landing or boating a fish, featuring an elongated shank body, on the forward end of which are pivotally mounted a pair of opposed jaws. A pair of control rods, symmetrically disposed on opposite sides of the shank body, are operably connected at their forward ends to the pivotal jaws and are arranged at their rearward ends to support and guide an actuating hand grip. Means connecting the control rods and jaws is arranged to provide maximum gripping force when the jaws are in or near their open position, and the jaws are arranged to overlap in their closed position.

U.S. Pat. No. 9,357,758 was issued on Jun. 7, 2016 to Darwin Smith for a “Fish-Grabbing Tool.” The fish-grabbing tool was designed to grab the side of a fish in certain situations, such as ice fishing, where the use of a net would be inappropriate or cumbersome. The fish grabbing tool positions a first jaw and a second jaw that can be positioned by the head or upper body of the fish. A pull ring is used to operate a grabbing mechanism that secures the first jaw and the second jaw aground the fish. Overall, the fish grabbing tool comprises a grabbing device, a center post, and a handle.

U.S. Pat. No. 3,833,252, issued on Sep. 3, 1974 to Donald E. Redding, covers a “Fish Retriever.” The Redding fish retriever has a pair of jaws that engage a fish from both sides, with tip portions of the jaws piercing the fish. The jaws are operated by links pivotally connected and operated by a slide movable in a supporting body portion. The slide is powered by a spring or similar means to forcefully close the jaws. Means are provided for opening the jaws so that they can be moved down over a fish. A trigger holds the slide in a cocked position, and when the slide is released, the jaws grasp the fish. In particular, the fish retriever includes (a) an elongated tubular body portion having upper and lower ends, with the body portion having an angularly extending portion at its upper end, forming a handle; (b) a pair of opposed, sharpened jaws pivotally supported on the lower end of the body portion, arranged for movement between an open position, for partially encircling a fish, and a closed position, for piercing opposite ends of the fish, where the jaws have a pivotal movement, such that in their closed position, the sharpened ends overlap in side-by-side relation; (c) a tubular slide, having guided longitudinal movement in the body portion; (d) diametral slots disposed upwardly in the body portion from its lower end; (e) a pair of links extending through the slots, and having a pivotal connected at one of their ends to the slide, and a pivotal connection at their other ends to respective jaws, whereby the jaws are opened upon upward movement of the slide in the body portion, and closed upon downward movement of the slide; (f) tension spring means disposed interiorly of the slide, where the spring means is anchored, at its lower end, to the body portion, and at its upper end to the slide, urging the slide downward in a force sufficient to cause the jaws to pierce a fish with the sharpened ends in overlapping relation; (g) a laterally extending grip member secured to the slide for manually moving the slide upwardly; (h) diametral slots featured on the body member, through which the grip member extends; (i) inter-engaging catch means at the upper end of the body portion and slide, arranged to hold the slide in an upper coked position; and (j) a trigger on the body portion with one end portion arranged to operate the catch means, and having its other end portion extending outwardly adjacent to the handle, and substantially parallel therewith, for engagement by the hand of the operator that grips the handle.

Lastly, U.S. Pat. No. 2,578,344 was issued on Dec. 11, 1951 to inventor W. L. Everett for “Fish and Crab Tongs.” The tongs were developed to provide a hand implement whereby fish, crabs, and other slippery or hard-to-hold seafood can be lifted and manipulated while counting, cleaning, or performing other desired tasks. The device features a pair of hands having finger-receiving openings, and elongated gripping member extending forwardly from one handle and having flat side faces and being arcuate throughout its length, to provide a longitudinally curved inner and outer side edges. A pair of elongated gripping members project forwardly from the other handle, in transversely spaced relation to each other, and being disposed against opposite sides of the first gripping member for a portion of their length, and pivotally connected thereto. A cross bar extends between the pair of gripping members and is secured to outer edge portions thereof, disposed across the first gripping member and spaced from the front ends of the gripping members.

What is needed is a fish restraining device to restrain a fish or similar creature during the process of removing a hook from the mouth, while not further harming the fish, and making it possible to either transfer the fish to a container or tank, or place the fish back in the water and release it.

### SUMMARY OF THE INVENTION

This invention provides a fish restraining device to restrain a fish or similar creature during the process of removing a hook from the mouth, while not further harming the fish, and making it possible to either transfer the fish to a container or tank or place the fish back in the water and release it, requiring only one-handed, simple manipulation by the person fishing.

The fish restraining device provides a frame body with a frame handle and a pull-up bar, and mechanical linkage between the pull-up bar and two end-clamping structures and a middle-clamping structure.

### BRIEF DESCRIPTION OF DRAWINGS

Reference will now be made to the drawings, wherein like parts are designated by like numerals, and wherein:

FIG. 1 is a schematic view of an embodiment of the fish restraining device of the invention, in use;

FIG. 2 is a perspective view of an embodiment of the fish restraining device of the invention in an open position;

FIG. 3 is a perspective view of an embodiment of the fish restraining device of the invention in a closed position;

FIG. 4 is a perspective view of a second embodiment of the fish restraining device of the invention, having springs;

FIG. 5 is a perspective view of a third embodiment of the fish restraining device of the invention in an open position; and

FIG. 6 is a perspective view of a third embodiment of the fish restraining device of the invention in a closed position.

### DETAILED DESCRIPTION OF THE INVENTION

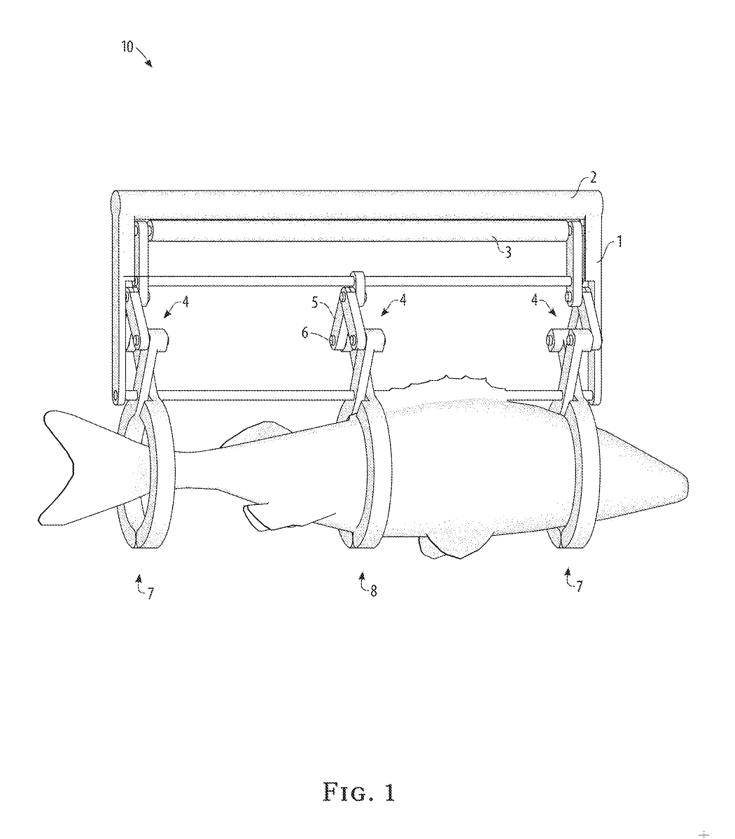

Referring to FIG. 1 and all of the figures generally, the fish restraining device 10 of the invention is shown. The fish restraining device 10 is used to restrain a fish or similar creature during the process of removing a hook from the mouth, while not further harming the fish, and making it possible to either transfer the fish to a container or tank or place the fish back in the water and release it.

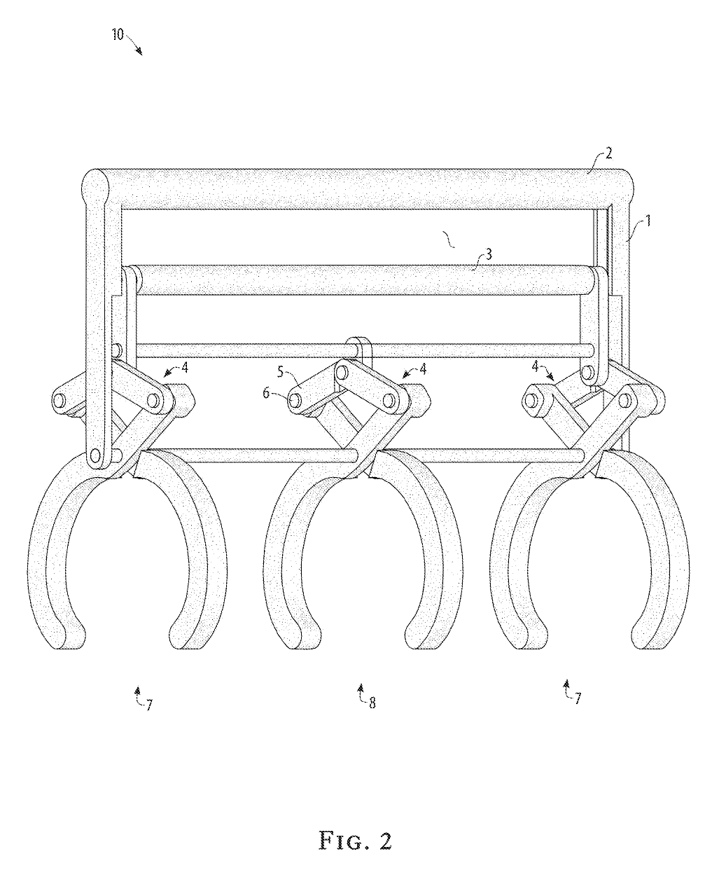

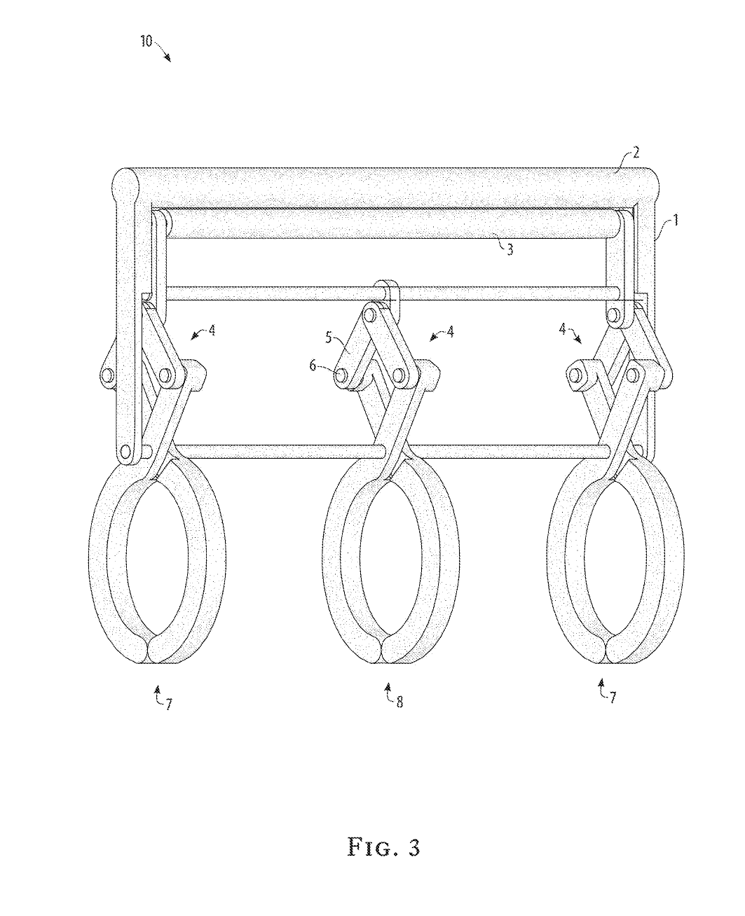

Referring additionally to FIG. 2 and FIG. 3, the fish restraining device 10 provides a frame body 1 having a frame handle 2 by which the fish restraining device 10 can be manipulated with one hand by a person fishing. A pull-up bar 3 is provided in a placement allowing the person fishing to pull it up or let it go using the fingers of the same hand used to hold the frame handle 2. The pull-up bar 3 is connected to one or more mechanical linkages 4 which transfer force in one direction placed on the pull-up bar 3 to force in a different direction placed upon two end-clamping structures 7 and one middle-clamping structure 8. In preferred embodiments of the fish restraining device 10, the mechanical linkage 4 provides links 5 and pin joints 6 as the mechanism for transferring force.

With reference to the restrained fish, having an anteroposterior or longitudinal axis, a dorsoventral or up-down axis, and a transverse or left-right axis, the two end-clamping structures 7 are positioned to restrain the fish at the anterior and posterior areas. Either end-clamping structure 7 can be positioned toward either end of the fish, simplifying the placement of the fish restraining device 10 in use. The middle-clamping structure is positioned to restrain the fish at the middle area. The three-point restraining of the fish neutralizes the fish's ability to bend significantly in a left-right direction. A restraint of fewer than three points would tend to allow the fish to either escape completely or to thrash and move so much as to negate the restraint.

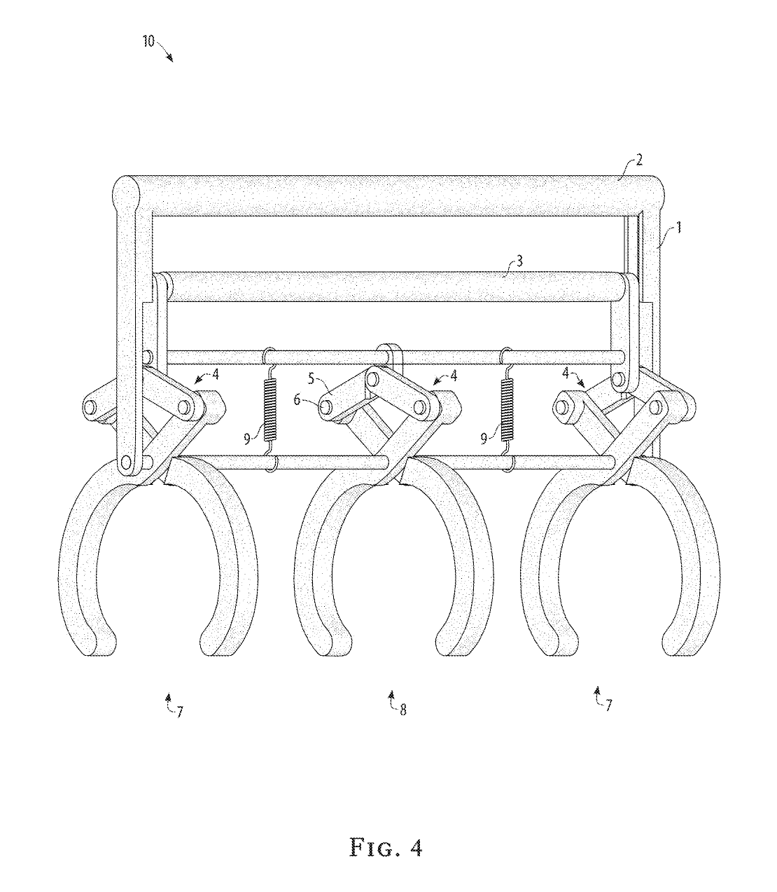

Referring briefly to FIG. 4, optionally, the fish restraining device can be provided with one or more springs 9 in order to more quickly and surely open the device.

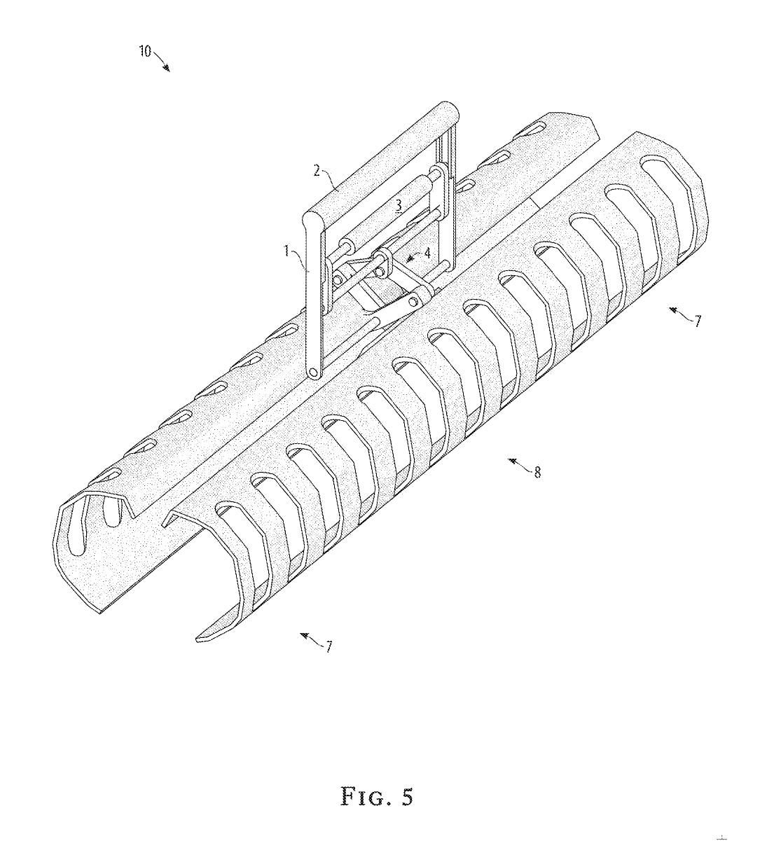

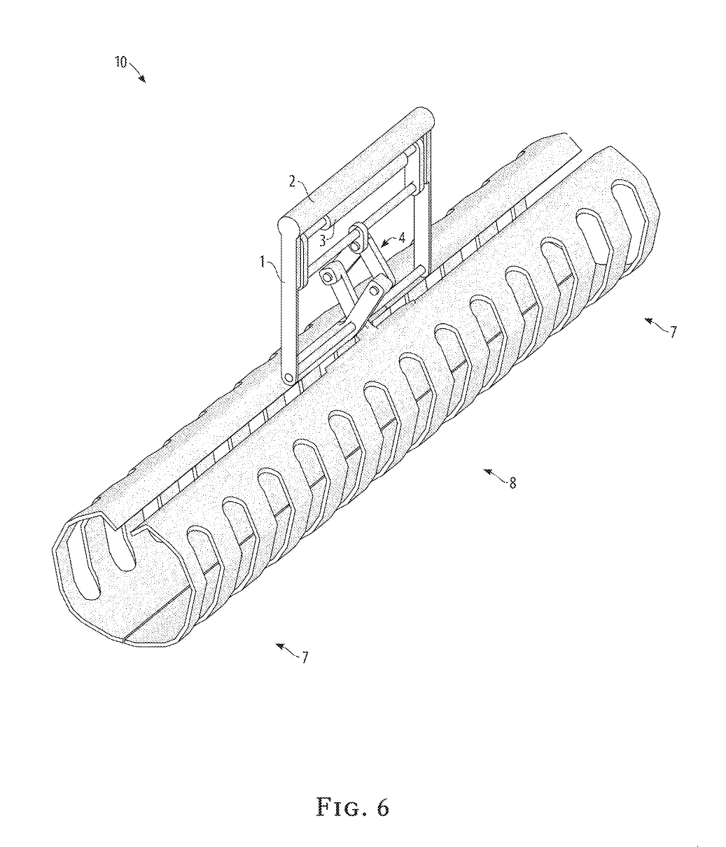

Referring briefly to FIG. 5 and FIG. 6, illustrating an embodiment where the two end-clamping structures 7 and middle-clamping structure 8 are connected so as to form single pieces, it is not necessary that the three points of restraint be achieved by disconnected structures. The clamping structures can be made of any of a number of sufficiently rigid and waterproof materials, such as metal or plastic. Single-piece structures can be provided with cut-outs to decrease weight while retaining sufficient strength.

The mechanical linkage 4 of the fish restraining device 10, again with reference to the restrained fish, receives an input force and movement that is aligned with the dorsoventral or up-down axis, resulting from an upward pulling or downward releasing of the pull-up bar 3. The mechanical linkage 4 functions as a kinematic chain transferring the up-down input movement into a clamping together or spreading apart output movement along the transverse or left-right axis. One, or more than one iterations of the mechanical linkage 4 can be provided in different embodiments. Where only one mechanical linkage 4 is used, the linkage should be robust enough to move the clamping structures.

In use, the fish restraining device 10 is easily manipulated with one hand by a person fishing, who will usually have the other hand occupied with other fishing gear or with navigation controls. The easy one-handed manipulation is beneficial in the sometimes challenging fishing conditions of limited space, wind, and, from a vessel or floating platform, wave movement. The upward pulling and releasing of the pull-up bar 3 is easily done with one hand. Placement of the fish restraining device 10 in use is simple, lining up the long axis of the fish restraining device with the long axis of the fish, without any concern for head-or-tail orientation. The fish is restrained while the hook is taken out of the mouth, and the fish is easily transferred to a container or back into the water.

Many other changes and modifications can be made in the system and method of the present invention without departing from the spirit thereof. I therefore pray that my rights to the present invention be limited only by the scope of the appended claims.

I claim:

1. A fish restraining device, to restrain a fish or similar creature, by a person fishing, during the process of removing a hook from the mouth, while not further harming the fish, the fish restraining device comprising:
(i) a frame body;
(ii) a frame handle mounted at an upper portion of said frame body;
(iii) a pull-up bar movably connected to said frame body, adapted to be manually pulled upward into close proximity to said frame handle;
(iv) two end-clamping structures adapted to restrain the head area and tail area of the fish;
(v) a middle-clamping structure adapted to restrain the longitudinally middle area of the fish;
(vi) at least one mechanical linkage adapted to transfer the input movements of the upward pulling and releasing of said pull-up bar into output movements of clamping and releasing of said end-clamping structures and said middle-clamping structure; where, in use, the person fishing, with one hand, aligns said fish restraining device longitudinally with the fish, places said end-clamping structures and middle-clamping structure over the fish, and pulls said pull-up bar to restrain the fish, and releases said pull-up bar to release the fish.

2. The fish restraining device of claim 1, further comprising at least one spring adapted to return said pull-up bar to a released position.

3. The fish restraining device of claim 1, where said mechanical linkage further comprises at least one link and at least one pin joint.

4. The fish restraining device of claim 1, where said frame body is made of metal.

5. The fish restraining device of claim 1, where said frame body is made of plastic.

6. The fish restraining device of claim 1, where said end-clamping structures and said middle-clamping structure are made of metal.

7. The fish restraining device of claim 1, where said end-clamping structures and said middle-clamping structure are made of plastic.

8. The fish restraining device of claim 1, where said end-clamping structures and said middle-clamping structure are provided in single compound units.

9. The fish restraining device of claim 1, where said end-clamping structures and said middle-clamping structure are provided as separate units.
